(19) United States
(12) Patent Application Publication
(10) Pub. No.: US 2006/0087788 A1
(43) Pub. Date: Apr. 27, 2006

(54) Dual-supply electronic circuit with means for protection against breakdowns, and corresponding protection means

(75) Inventors: Stanislas Gibet, Carquefou (FR); Abdellatif Bendraoui, Saint-Julien de Concelles (FR); Mikael Tual, Saint-Nazaire (FR)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Atmel Nantes SA, Nantes Cedex 3 (FR)

(21) Appl. No.: 11/227,464

(22) Filed: Sep. 15, 2005

(30) Foreign Application Priority Data
Sep. 15, 2004 (FR) 04/09843

(51) Int. Cl. H02H 3/00

(52) U.S. Cl. 361/100

(57) ABSTRACT

An electronic circuit is provided, which includes a dual supply having a first supply for a first portion of said circuit and a second supply for a second portion of said circuit. The electronic circuit further includes a protection circuit for protecting at least one transistor of said first portion. The protection circuit includes a first protection transistor of which the drain is connected to a connection between said first portion and said second portion and the gate is connected to said first power supply. A voltage reducer reduces the voltage between the drain and the gate of said first protection transistor.

### CROSS-REFERENCE TO RELATED APPLICATION

The present application claims priority of French Application No. FR 04/09843, filed Sep. 15, 2004, not in English.

### FIELD OF THE INVENTION

This invention relates to the field of integrated electronic circuits and more specifically dual-supply integrated circuits.

More specifically, the invention relates to the protection of these integrated circuits, in particular against transistor breakdowns and electrostatic discharge.

### BACKGROUND OF THE INVENTION

Integrated circuits have traditionally operated with a standard power supply of around 5V. However, the increasing need to reduce the consumption and size of electronic systems based on integrated circuits has led the designers of such circuits to reduce the supply voltages.

However, the standardisation of supply voltages takes time and the reduction of supply voltage does not have the same level of priority in all applications of the electronics industry. Thus, components operating at 5V, according to the former standards, are often interconnected with components operating with lower supplies, according to the new standards, in order to produce electronic systems.

To be capable of producing these “mixed”-supply or dual-supply electronic systems, integrated circuit designers must make sure that the components operating according to the new lower supply voltages are not abnormally damaged when they must communicate with systems operating at 5V.

Circuits must thus be protected against the risks of:

junction breakdowns;

gate oxide breakdown;

undesirable leakage currents.

A major problem of integrated electronic circuits is their sensitivity to electrostatic discharges. Electric discharge is a very high voltage and very brief electrical pulse generally caused by static electricity.

Indeed, when electrostatic discharge is applied to a transistor, its oxide layer can be destroyed or damaged. For this reason, the input/output contacts (or input/output pads) of an integrated circuit must be protected so that the electric discharges do not reach its oxide layers.

Several techniques have been proposed for protecting an integrated circuit from the effects of electrostatic discharge.

A first technique is based on implementing two diodes, one connected between the input/output contact of the circuit and the circuit ground, and the other between a circuit power supply and the input/output contact. Thus, according to the electrostatic discharge sign, the diode passing through short-circuits the discharge current either towards the ground or towards the power supply plane.

However, in normal operation and when a higher voltage than the supply voltage is applied to the input/output contact, it is short-circuited towards the power supply by one of the diodes. Thus, a voltage higher than the power supply cannot be applied to the input/output contact, which prevents such a circuit supplied, for example, at 3V from being placed in an electronic system operating at 5V according to the former power supply standards.

A second known technique for protecting an integrated circuit 10 including a logic module 101 is shown in FIG. 1. It involves an NMOS transistor 11, of which the drain is connected to an input/output contact 12 of the circuit 10, the source is connected to the ground 13 of the circuit 10 and the gate is connected via a first resistor 16 to the ground 13. This NMOS transistor 11 short-circuits the electrostatic current of the negative discharges towards the ground.

For positive discharges, this technique involves a transistor PMOS 14, of which the source is connected to the input/output contact 12, the drain is connected to the power supply 15 and the gate is connected, via a second resistor 17, to the power supply 15. The latter plays a role symmetric to that of the NMOS transistor 11 by short-circuiting the electrostatic current of the positive charges towards the power supply 15.

In the case of a power supply 15 of 3V, the application of a voltage of 5V on the input/output contact 12 generates a drain-gate voltage higher than the gate oxide of the NMOS transistor 11 can support. Thus, there is an abnormal damage to the channel and the oxide layer and a risk of breakdown of the NMOS transistor 11 if such a circuit 10 supplied at 3V is used in an electronic system operating at 5V.

A third technique for protecting an integrated circuit 20 including a logic module 201 is presented in document U.S. Pat. No. 5,932,918, and shown in FIG. 2. It involves two NMOS transistors 211 and 212 stacked for protection against the negative electrostatic discharges. For the positive electrostatic discharges, an assembly based on a PMOS transistor 24 and a resistor 27, identical to that of FIG. 1, is implemented.

The drain of the first transistor 211 is connected to the input/output contact 22 as well as to the PMOS transistor 24, its gate is connected to the power supply and its source is connected to the drain of the second transistor 212. The gate of the second transistor 212 is connected via a resistor 26 to the ground 23 of the circuit 20 and its source is also connected to the ground 23.

As in the second technique, in the case, for example, of a power supply 25 of 3V, the application of a voltage of 5V on the input/output contact 22 generates a drain-gate voltage higher than the gate oxide of the first transistor 211 can support. Thus, this third technique also presents problems of abnormal damage and a risk of breakdown of the transistor 211 if such a circuit 20 supplied at 3V is used in a system operating at 5V according to the former standards.

### SUMMARY OF THE INVENTION

The aim of an embodiment of the invention is in particular to overcome these disadvantages of the prior art.

More specifically, an aim of an embodiment of the invention is to provide such a technique that enables the circuits to be protected from breakdowns and abnormal damage to their components when they receive a voltage higher than their supply voltage.

Another aim of an embodiment of the invention is to provide a new technique for protecting dual-supply integrated circuits, in particular from electrostatic discharges.

An embodiment of the invention also aims to provide such a technique that occupies only a small silicon surface and does not require an additional step in the circuit production process.

An embodiment of invention also aims to provide such a technique that is easy and inexpensive to implement.

These objectives, as well as others described below, are achieved, in an embodiment of the invention, by means of an electronic circuit including a dual supply, a first supply being for a first portion of said circuit and a second supply being for a second portion of said circuit, and a protection circuit for protecting at least one transistor of said first portion, including a first protection transistor of which the drain is connected to a connection between said first portion and said second portion and of which the gate is connected to said first power supply.

According to an embodiment of the invention, such a circuit includes a voltage reducer for reducing the voltage between the drain and the gate of said first protection transistor.

The reduction of the voltage between the drain and the gate of the first transistor thus provides protection against any abnormal damage or even against the breakdown resulting from the application of high voltages to this transistor. This technique therefore protects the circuit from electrostatic discharges.

Advantageously, said first protection transistor is mounted in a diode structure.

Said first voltage-reducing means preferably include a first resistor mounted between the gate and the source of said first transistor.

These voltage-reducing means thus occupy a small silicon surface and do not require additional steps in the circuit production process.

In addition, these voltage-reducing means are simple and inexpensive.

According to an advantageous feature of an embodiment of the invention, said first resistor is mounted between said first power supply and the gate of said first protection transistor, with the source of the latter directly connected to said first power supply.

Preferably, said protection means include a second transistor, of which the drain is connected to the source of said first transistor and the source is connected to the ground.

According to a preferred embodiment of the invention, said protection means include a second resistor, interconnecting the gate and the source of said second transistor.

Said first and second transistors are preferably identical.

Said protection means advantageously include a third transistor of which the source is connected to said connection between said first portion and said second portion and of which the drain is connected to said first power supply.

According to an advantageous feature of the invention, said protection means include a third resistor, interconnecting the gate and the drain of said third transistor.

According to a preferred embodiment of the invention, said third transistor is a floating-substrate transistor.

Said protection means advantageously include at least one resistor connected to the drain of said first transistor and/or said second transistor, respectively.

According to a preferred feature of the invention, at least one of said resistors is obtained by at least one of the techniques comprised in the group including:

the addition of an additional zone between the gate and the drain or the source of the concerned protection transistor;

doping by implanting nitrogen and/or phosphorus ions;

removing a silicide from said additional zone.

Said first portion of said circuit advantageously includes logic means and said second portion includes input/output means.

An embodiment of the invention also relates to means for protecting an electronic circuit including a dual supply, a first supply being for a first portion of said circuit and a second supply being for a second portion of said circuit, which protection means provide protection for at least one transistor of said first portion, including a first protection transistor of which the drain is connected to a connection between said first portion and said second portion and of which the gate is connected to said first power supply.

Said protection means include first means for reducing the voltage between the drain and the gate of said first protection transistor.

### BRIEF DESCRIPTION OF THE DRAWINGS

Other features and advantages of the invention will become more clear from the following description of a preferred embodiment, given as a simple illustrative and non-limiting example, and appended drawings, in which:

FIGS. 1 and 2 show two techniques of the prior art, already described above;

FIG. 3 shows the protection means of an embodiment of the invention;

FIG. 4 is an example of a variation curve of the drain-source current on the basis of the drain-source voltage of the prior art and according to an embodiment of the invention.

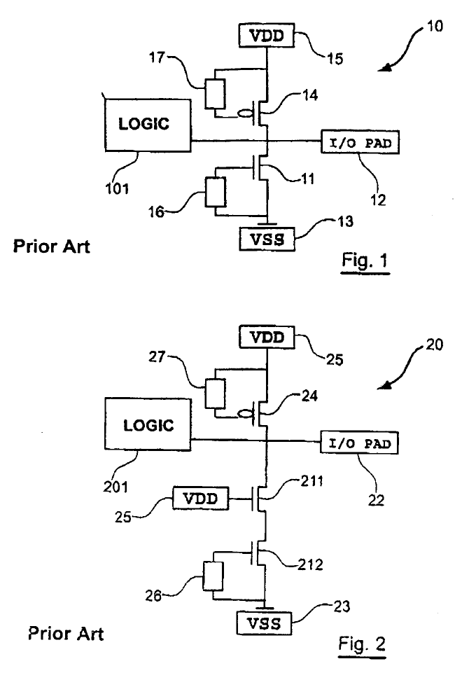

### DETAILED DESCRIPTION OF ILLUSTRATIVE EMBODIMENTS

The general principle of an embodiment of the invention lies in the use of means for protection against abnormal damage of two stacked transistors of a device for protecting an integrated circuit against the damage caused by electrostatic discharges. According to the invention, the drain-gate voltage of the first transistor is reduced, for example using a resistor, in order to prevent breakdown problems.

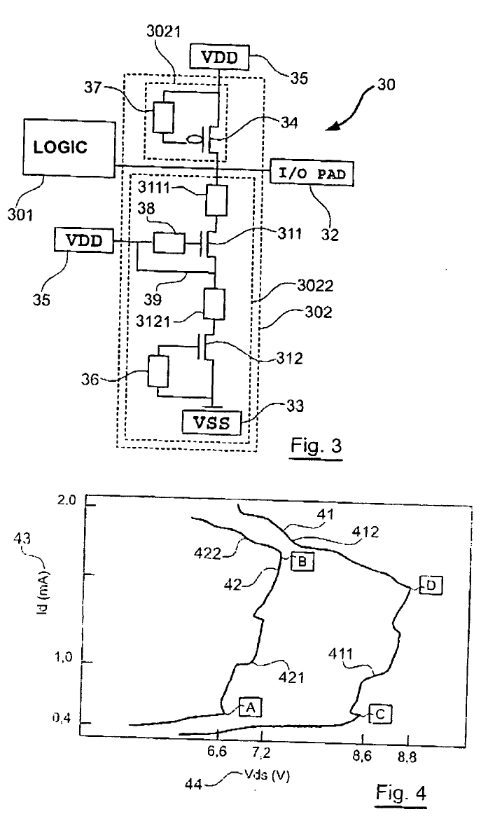

FIG. 3 shows a preferred embodiment of a protection device or circuit 302 according to the invention for protection against the damage caused by electrostatic discharges in an integrated circuit 30.

The circuit 30 includes a logic module 301, a power supply 35 of 3V and an input/output contact 32 intended to be connected to another integrated circuit supplied, for example, by means of a second power supply of 5V.

The protection device 302 includes an upper portion 3021 dedicated to positive electrostatic discharges. This upper portion 3021 includes a transistor PMOS 34, of which the source is connected to the input/output contact 32, the drain is connected to the power supply 35 and the gate is connected, via a resistor 37, to the power supply 15. The resistor value 37 is, for example, 1 kΩ.

This portion 3021 protects the circuit 30 from positive electrostatic discharges by short-circuiting the electrostatic current of these discharges towards the power supply 35.

The protection device 302 also includes a lower portion 3022 dedicated to negative electrostatic discharges. This lower portion 3022 includes two stacked NMOS transistors 311, 312. These NMOS transistors 311, 312 protect the circuit from negative electrostatic discharges by short-circuiting the electrostatic current of these discharges towards the ground.

The drain of the first transistor 311 is connected to the input/output contact 32 as well as to the PMOS transistor 34 and its source is connected to the drain of the second NMOS transistor 312. The gate of the second NMOS transistor 312 is connected, via a resistor 36, of which the value is, for example, 1 Ω, to the ground 33 of the circuit 30, and its source is also connected to the ground 33.

As explained above with regard to FIG. 2, when a voltage higher than the supply voltage 35 (of 3V), for example 5V, is applied to the input/output contact 32, a high voltage is consequently imparted on the NMOS 311, 312 and PMOS 34 transistors. Abnormal damage to the materials, such as the oxide layers or the junction channels of these transistors 311, 312 can result and rapidly lead to the breakdown of these transistors 311, 312.

Therefore, means for protection against this abnormal damage are provided in the protection device 302 according to an embodiment of the invention. According to an embodiment of the invention, these means are included in the lower portion 3022.

These means include a protection resistor 38 connected by a first end to the gate of the first NMOS transistor 311 and by a second end to the power supply 35. This protection resistor 38 enables the voltage applied between the drain and the gate of the NMOS transistor 311 to be reduced, and thus the abnormal damage to this transistor to also be reduced. The value of the protection resistor 38 is, for example, 500 Ω.

These means also include a link 39 connecting the second end of the protection resistor 38 to the source of the first transistor 311. The link 39 enables the voltage applied between its drain and its gate to be reduced, via the protection resistor 38, so as to reduce abnormal damage to this transistor.

To prevent abnormal damage to the PMOS transistor 34, it is advantageously provided on a floating substrate which can eliminate the leakage current when the junction is reversely polarized.

The stacking of the two NMOS transistors 311 and 312 allows for good protection against electrostatic discharges. This is shown in FIG. 4, which shows a comparison between a first feature 41 of the drain-source current 43 labelled Id on the basis of the drain-source voltage 44 (labelled Vds) of the transistor 311 of the circuit of FIG. 3, and a second feature 42 for the NMOS transistor of a protection device according to the prior art including only one transistor in the lower portion dedicated to negative electrostatic discharges.

A first advantage of an embodiment of invention is therefore that the stacking of the two transistors 311, 312 helps to delay the appearance of the hot carrier phenomenon, which is characterised on each of the features 42, 41, respectively, by a bump A, C. Indeed, for the second feature 42 (a single transistor), the bump A corresponds to Vds=6.6 V, while for the first feature 41 (stacking of two transistors), the bump A corresponds to Vds=8.6 V. Thus, a delay of substantially 2 V in the hot carrier phenomenon can be observed.

A second advantage is that, owing to the stacking, the so-called “snap back” phenomenon is also delayed. Indeed, for the second feature 42, the point B in which the slope changes signs, which characterises the appearance of this phenomenon, corresponds to Vds=7.2 V, while for the first feature 41, point D corresponds to Vds=8.8 V. Thus, a delay in the “snap back” phenomenon of substantially 1.6 V can be observed.

According to a preferred embodiment of the invention, a resistor 3111, 3121 is added to the drain of each of the NMOS transistors 311, 312 of the circuit of FIG. 3. These resistors 3111, 3121, of which the value is, for example, 7 Ω, make it possible to achieve a change in the sign of the slope of the characteristic 42 Id as a function of Vds (cf. FIG. 4) characterising the input in the “snap back” zone.

These resistors 3111, 3121 are produced in the design of the NMOS transistors 311, 312 by means of the following steps:

the addition of an additional zone between their gate and their drain by increasing the polycontact distance;

the doping of this zone by implanting arsenic and/or phosphorus ions;

the removal of the silicide from this additional zone.

Of course, the invention is not limited to the embodiments mentioned above.

In particular, a person skilled in the art can apply any alternative to the means for protection against abnormal damage to the transistors of the device for protecting the integrated circuit from electrostatic discharges.

In particular, a person skilled in the art can use protection circuits including other electronic components, in the amounts and in the locations suitable for the features of the integrated circuits, their protection device and the voltage provided at the output of the circuit.

Similarly, according to the alternatives of these embodiments, the protection circuits can be implemented in other locations of the integrated circuits.

Although the present invention has been described with reference to preferred embodiments, workers skilled in the art will recognize that changes may be made in form and detail without departing from the spirit and scope of the invention.

What is claimed is:

1. An electronic circuit comprising:
a dual supply comprising a first power supply for a first portion of said circuit and a second power supply for a second portion of said circuit; and
a protection circuit for protecting at least one transistor of said first portion, including a first protection transistor of which the drain is connected to a connection between said first portion and said second portion and the gate is connected to said first power supply, wherein said first protection transistor is mounted in a diode structure; and
a first voltage reducer for reducing the voltage between the drain and the gate of said first protection transistor.

2. The electronic circuit according to claim 1, wherein said first voltage reducer includes a first resistor mounted between the gate and the source of said first protection transistor.

3. The electronic circuit according to claim 2, wherein said first resistor is mounted between said first power supply and the gate of said first protection transistor, with the source of the first protection transistor being connected directly to said first power supply.

4. The electronic circuit according to claim 1, wherein said protection circuit includes a second protection transistor, of which the drain is connected to the source of said first protection transistor and the source is connected to ground.

5. The electronic circuit according to claim 5, wherein said protection circuit includes a second resistor, interconnecting the gate and the source of said second protection transistor.

6. The electronic circuit according to claim 4, wherein said first and second protection transistors are identical.

7. The electronic circuit according to claim 1, wherein said protection circuit includes a third protection transistor of which the source is connected to said connection between said first portion and said second portion and the drain is connected to said first power supply.

8. The electronic circuit according to claim 7, wherein said protection circuit includes a third resistor, interconnecting the gate and the drain of said third protection transistor.

9. The electronic circuit according to claim 8, wherein said third protection transistor is a floating-substrate transistor.

10. The electronic circuit according to claim 4, wherein said protection circuit includes at least one resistor connected to the drain of said first protection transistor and/or said second protection transistor, respectively.

11. The electronic circuit according to claim 10, wherein at least one of said resistors is at least partially defined by features in the group including:
an additional zone between the gate and the drain or the source of the protection transistor concerned;
doping comprising implanted nitrogen and/or phosphorus ions; and
removal of silicide from said additional zone.

12. The electronic circuit according to claim 1, wherein said first portion of said circuit includes a logic circuit and said second portion includes input/output circuit.

13. An apparatus for protecting an electronic circuit comprising:
a dual supply, including a first power supply for a first portion of said circuit and a second power supply for a second portion of said circuit,
a first protection transistor for protecting at least one transistor of said first portion, comprising a drain connected to a connection between said first portion and said second portion and a gate connected to said first power supply, wherein said first protection transistor is mounted in a diode structure; and
a voltage reducer, which reduces voltage between the drain and the gate of said first protection transistor.

14. An electronic circuit including a dual supply comprising a first supply being for a first portion of said circuit and a second supply being for a second portion of said circuit and means for protecting at least one transistor of said first portion, including a first protection transistor of which the drain is connected to a connection between said first portion and said second portion and the gate is connected to said first power supply, wherein said first protection transistor is mounted in a diode structure and said electronic circuit includes means for reducing the voltage between the drain and the gate of said first protection transistor.

15. Means for protecting an electronic circuit including a dual supply comprising a first supply being for a first portion of said circuit and a second supply being for a second portion of said circuit, wherein the protection means provide protection for at least one transistor of said first portion, including a first protection transistor of which the drain is connected to a connection between said first portion and said second portion and the gate is connected to said first supply, and wherein said first protection transistor is mounted in a diode structure and said means for protecting include first means for reducing the voltage between the drain and the gate of said first protection transistor.
